(19) United States
(12) Patent Application Publication
(10) Pub. No.: US 2019/0083917 A1
(43) Pub. Date: Mar. 21, 2019

(54) SMART AIR FILTER APPARATUS AND SYSTEM

(71) Applicant: Alea Labs, Inc., Redwood City, CA (US)

(72) Inventors: Hamid NAJAFI, Los Altos Hills, CA (US); Hamid FARZANEH, Redwood City, CA (US); Bhusan GUPTA, Palo Alto, CA (US)

(21) Appl. No.: 16/133,188

(22) Filed: Sep. 17, 2018

Related U.S. Application Data
(60) Provisional application No. 62/606,273, filed on Sep. 18, 2017.

(51) Int. Cl. B01D 46/42; B01D 46/46; F24F 3/16; F24F 11/56

(52) U.S. Cl. CPC B01D 46/429; B01D 46/4245; B01D 46/46; F24F 2110/50; F24F 11/56; B01D 2279/50; F24F 3/1603

(57) ABSTRACT

A smart air filter housing is provided comprising at least one air filter frame connected to a data measurer and having a wireless communicator. The wireless communicator may interface directly with an HVAC system controller. The data measurer may be a humidity sensor, a temperature, air quality sensor, a microphone, or any other sensor capable of detecting qualities of the air flowing through the HVAC return chamber. The smart air filter housing may be embodied by having a compliance determiner to determine whether an inserted air filter is suitable to the smart air filter housing. The smart air filter housing may also be embodied by having an energy harvester.

### CROSS REFERENCE TO RELATED APPLICATIONS

The present application claims the benefit of priority to U.S. Provisional Patent Application No. 62/606,273, filed Sep. 18, 2017, all of which is incorporated by reference in its entirety.

### FIELD OF THE INVENTION

At least one embodiment of the present invention pertains to a smart air filter system with ability to monitor, detect, and report when it is time for it to be replaced by a new clean filter. Such a smart filter helps improve the quality of air delivered by the HVAC system and can improve the efficiency of the HVAC system.

### BACKGROUND

A vast majority of homes and offices in the U.S. and other countries use a “forced air” system for heating and cooling the interior of the building. In many of these systems there is normally an air filter in the return air path that cleans the air before the air is conditioned and is blown into the rooms. The HVAC users or the HVAC maintenance people have to visually check the status of the air filter at regular intervals to determine if it needs to be replaced. Often the users forget to do this checking and replacing resulting in impaired air quality and significantly higher energy consumption of the HVAC system.

An air filter is typically placed in the return air path, and the air filter cleans the air before the air is conditioned and is blown into the rooms. The air filter provides only one central point for air filtration for the whole building.

The air filter is in some instances used to keep dust and other particulate matter from building up in ducts and the HVAC system generally. Air filters can also be designed to remove microscopic particles like dust, pollen, pet dander, bacteria, plant and mold spores, and even smoke. Air filters are intended to be replaced periodically, and are typically slotted into a housing in the HVAC system specifically designed to hold air filters.

Over time, with the cumulative volume of air circulated through the central blower, the air filter becomes progressively more blocked from a variety of pollutants, of a variety of sizes and types. Partial blockage of the air filter can lead to a decreased performance of the central blower, or of an inability of the filter to remove unwanted particulate matter from the air, resulting in poor air quality within the space being served by the central blower.

The HVAC users, occupants, or the HVAC maintenance people have to visually check the status of the air filter at regular intervals to determine if it needs to be replaced. The occupant may adhere to one of a variety of general rules of thumb in establishing a filter changing schedule. Often the users forget to check and/or replace an air filter, resulting in impaired air quality and significantly higher energy consumption of the HVAC system.

A visual inspection is not the most reliable and accurate means of assessing the blockage present in a filter. For instance, occupants with difficulty perceiving colors may not be able to ascertain the state of a filter. Premature replacement due to a user misjudging the state of the air filter can lead to increased overall costs of operating systems.

There are some sensors available in the market that can be attached to the air filter, or placed elsewhere in the forced air path. They use air pressure measured on one or both sides of the air filter to determine whether the air filter is clogged and needs to be replaced. The air pressure alone may not be an accurate method to detect whether the filter is dirty or clogged because the air pressure measurement can be affected by other factors such as opening and closing of the vents, variability of the blower speed and external factors such as the temperature and humidity of the return air. The air pressure measurement is only valid when the HVAC system is in operation as the movement of air across the filter may result in a pressure difference if there is resistance to the airflow caused by a dirty filter.

To properly detect the status of the air filter, and not be affected by the variabilities inherent in the HVAC system air flow, this invention uses an optical sensor which shines some wavelength or wavelengths of light through or on the filter and measures the amount of light on the other side, or the same side as a reflective sensor, as a measure of the cleanliness of the filter. This sensing mechanism can be further supplemented by one or more sensors namely air quality sensors, temperature sensors, humidity sensors, and pressure sensors. As an alternative to the optical sensing system, conductive plates or wires can be built into the filter and act as capacitor terminals which change their mutual capacitance as a function of the dirt accumulated on the filter. An embodiment of the filter sensor system could use one or more of the aforementioned measurement systems (pressure, optical, capacitive) to provide the best overall filter status signal.

Accordingly, the lack of a means of assessing filter blockage in a reliable and timely manner makes a conventional HVAC systems inefficient in terms of efficiency, air quality and energy savings.

A more reliable means of detecting air filter degradation, and a means of enabling disabled people to detect air filter degradation is desirable.

### SUMMARY

This summary is provided to introduce in a simplified form certain concepts that are further described in the Detailed Description below and the drawings. This summary is not intended to identify essential features of the claimed subject matter or to limit the scope of the claimed subject matter.

In a first aspect, a smart air filter housing is provided. The housing comprises an air filter frame suitable to being inserted into a return air chamber of an HVAC system, for containing an air filter; at least one data measurer connected to the air filter frame and configured to measure data related to the state of an air filter resident within the frame; a controller connected to the air filter frame, in communication with the at least one data measurer; a wireless communicator connected to the air filter frame, in communication with the controller; and a power connector, connected to the air filter frame, configured to receive power from a power source suitable to powering the at least one data measurer and the wireless communicator.

In a further aspect, at least one of the data measurer and the wireless communicator is connected to the air filter frame via a connector.

In a further aspect, the air filter frame is made of one or more materials selected from the following list: metal, wood, and plastic.

In a further aspect, the connector is positioned to direct the data measurer towards the air filter.

In a further aspect, connector is positioned to direct the data measurer parallel to the air filter.

In a further aspect, the housing further comprises a battery, and the battery is connected to the air filter and the power connector.

In a further aspect, the battery is connected to the air frame filter and the power connector.

In a further aspect, the housing further comprises an energy harvester connected to the air filter frame and the power connector, the energy harvested being configured to harvest energy and provide the energy to the power connector.

In a further aspect, the at least one data measurer comprises at least one of the following: an optical emitter, an optical receiver, a pressure sensor, a capacitance determiner, a temperature sensor, a microphone, a humidity sensor, a force sensor, an air quality sensor, and a compliance determiner.

In a further aspect, the at least one data measurer comprises a compliance determiner configured to determine whether an air filter inserted into the frame complies with a compliance standard.

In a further aspect, the at least one data measurer comprises a compliance determiner configured to allow an air filter to determine if a compliance element attached to the air filter meets a compliance standard.

In a further aspect, the wireless communicator is configured to communicate to a first wireless transceiver via Near Field Communication (NFC), Radio Frequency ID (RFID).

In another aspect, a method of operating a smart air filter housing is provided. The method comprises sending readings from a data measurer connected to an air filter frame to a wireless communicator, and sending the readings from the wireless communicator to a first wireless transceiver.

In a further aspect, the step of sending readings from the data measurer to the wireless communicator comprises: sending the readings from the data measurer to a controller, and sending the readings from the controller to the wireless communicator.

In a further aspect, one or more of the data measurer and the wireless communicator operates in a low power mode, and awakens in response to a wake up event.

In a further aspect, the wake up event comprises receiving a message from the first wireless transceiver.

In a further aspect, the step of sending readings to the first wireless transceiver occurs in response to receiving a message from the first wireless transceiver.

In a further aspect, the message from the first wireless transceiver is sent as a result of a remote controller utilizing operational logic.

In a further aspect, in response to sending the readings from the wireless communicator to the first wireless transceiver, a remote controller utilizes operational logic to determine whether the readings meet a threshold.

In a further aspect, if the threshold is satisfied, the remote controller sends a message to a user device.

In a further aspect, if the threshold is satisfied, the remote controller alters the operation of an HVAC system.

In a further aspect, the threshold is determined based on at least one of historical sensor data and manufacturer data.

Other aspects of the technique will be apparent from the accompanying figures and detailed description. Further example embodiments of the claimed subject matter will be appreciated from the following detailed description and drawings.

### BRIEF DESCRIPTION OF THE DRAWINGS

One or more embodiments of the present invention are illustrated by way of example and not limitation in the figures of the accompanying drawings, in which like references indicate similar elements.

FIG. 1 is a front view of an example smart air filter housing with one data measurer.

FIG. 2 is a front view of an alternate embodiment of the smart air filter housing.

FIG. 3 is a front view of an alternate embodiment of the smart air filter housing.

FIG. 4 is a simplified front view of an example smart air filter housing showing the various surfaces and sides.

FIG. 5 is a further simplified front view of a smart air filter housing showing the various surfaces and sides.

FIG. 6 is a front view of an alternate embodiment of the smart air filter housing with an energy harvester and a compliance determiner.

FIG. 7 is a block diagram of an example embodiment of the smart air filter housing interacting with an external wireless transceiver and other elements of a communication network.

FIG. 8 is an exemplary method of operating a smart air filter housing.

### DETAILED DESCRIPTION

The making and using of the presently described embodiments are discussed in detail below. The specific embodiments discussed are merely illustrative of specific ways to make and use the invention, and do not limit the scope of the invention.

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, such references are not necessarily mutually exclusive either.

Disclosed herein are smart air filter housings that measure the state of air filters based at least in part on data collected by data measurers included in an air filter frame. A smart air filter housing is suitable to being inserted into the return air chamber of an HVAC system. The smart air filter housing may be removable from the air chamber of an HVAC system, or in an alternate embodiment, the smart air filter housing is connected directly into the air chamber of an HVAC system, such that the smart air filter housing is not removed when replacing an air filter.

A person skilled in the art will appreciate that the dimensions of the rectangular prism frame will allow for an air filter to fit into the frame. The air filter frame in the smart air filter housing is suitable to containing an air filter resident within itself. Air filters come in a variety of shapes and sizes, many of which are substantially a rectangular prism frame.

In some embodiments, the air filter frame is provided having a substantially a rectangular prism frame. The rectangular prism frame may consist of rectangular base frames connected via vertical supporting members. The rectangular base frames and vertical supporting members may have sidewall elements connected thereto. Sidewalls, rectangular base frames and vertical supporting members may provide a connection surface for data measurers, processors, controllers, antenna, connectors, etc.

Example embodiments will now be described in detail with reference to the drawings.

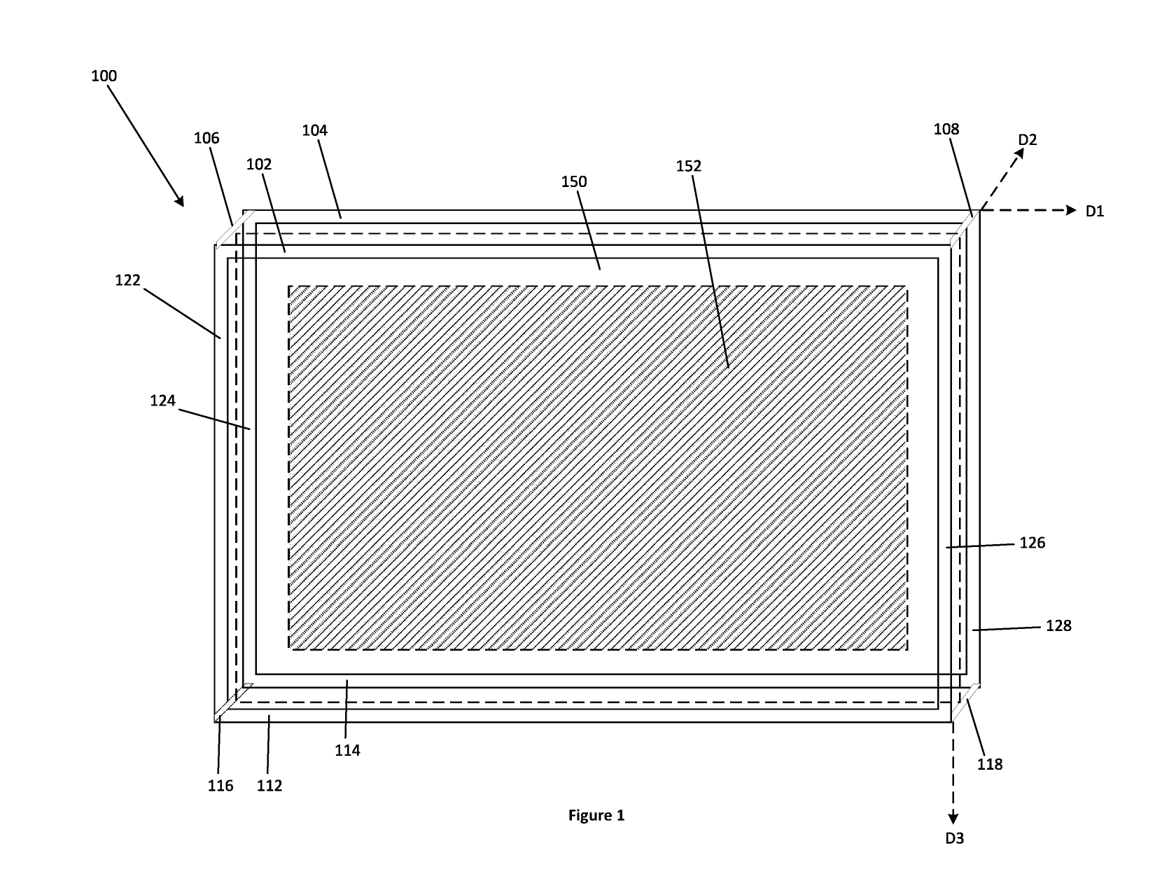

FIG. 1 is a front view of an example embodiment of a smart air filter housing 100. Smart air filter housing 100 has first upper longitudinal member 102 and second upper longitudinal member 104 that are parallel in a first direction D1 and opposite to each other, and first upper horizontal member 106 and second upper horizontal member 108 that are parallel to one another in a second direction D2, wherein D2 is perpendicular to D1.

Smart air filter housing 100 further comprises a first lower longitudinal member 112 and second lower longitudinal member 114 that are parallel in D1 and opposite to each other, and first lower horizontal member 116 and second lower horizontal member 118 that are parallel to one another in D2.

Smart air filter housing 100 further comprises a first left vertical member 122, a second left vertical member 124, a first right vertical member 126 and a second right vertical member 128 that are parallel in D3, and perpendicular to D1 and D2.

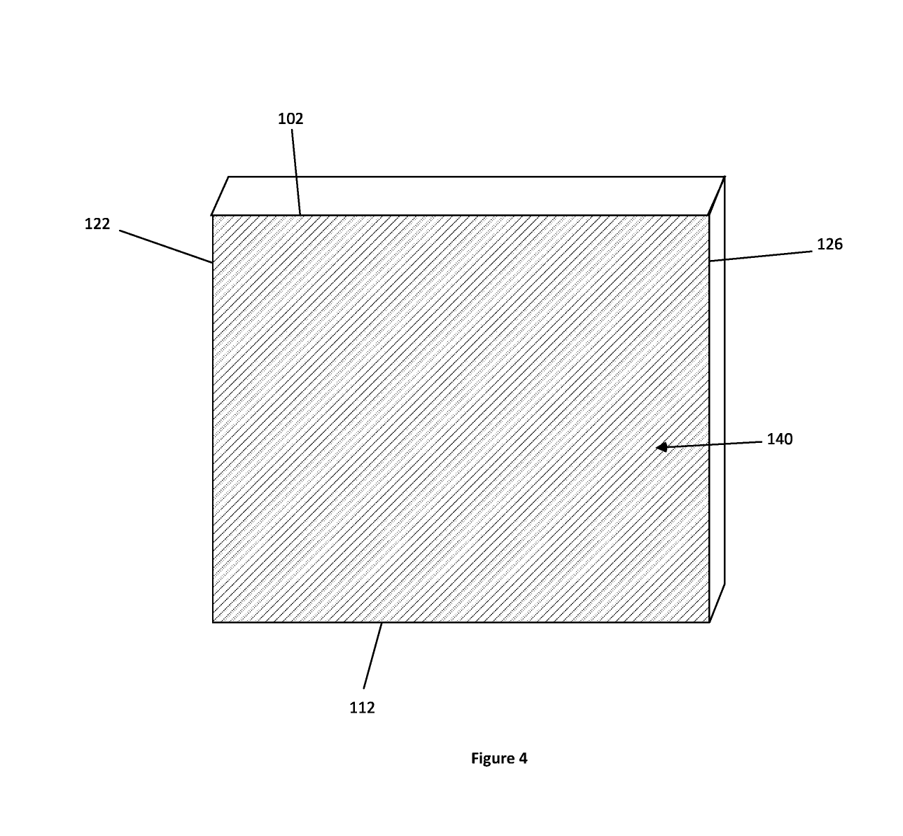

Referring now to FIG. 4, which is a front view of an example embodiment, first left vertical member 122, first right vertical member 126, first lower longitudinal member 112 and first upper longitudinal member 102 define a first flow through aperture 140.

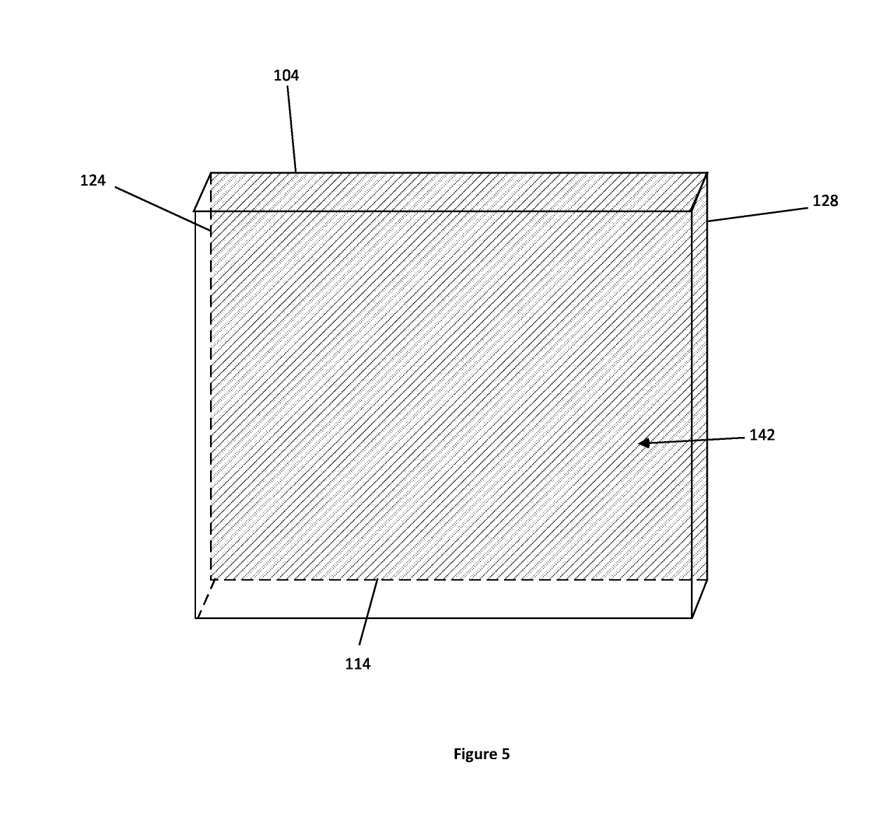

Referring now to FIGS. 4-5, second left vertical member 124, second right vertical member 128, second lower longitudinal member 114, and second upper longitudinal member 104 define a second flow through aperture 142.

Referring again to FIG. 1 and FIG. 5, smart air filter housing 100 is incorporated into a HVAC system (not shown), such that the air from the return chamber (not shown) passes through the flow through apertures 140 and 142 through a plane perpendicular to same.

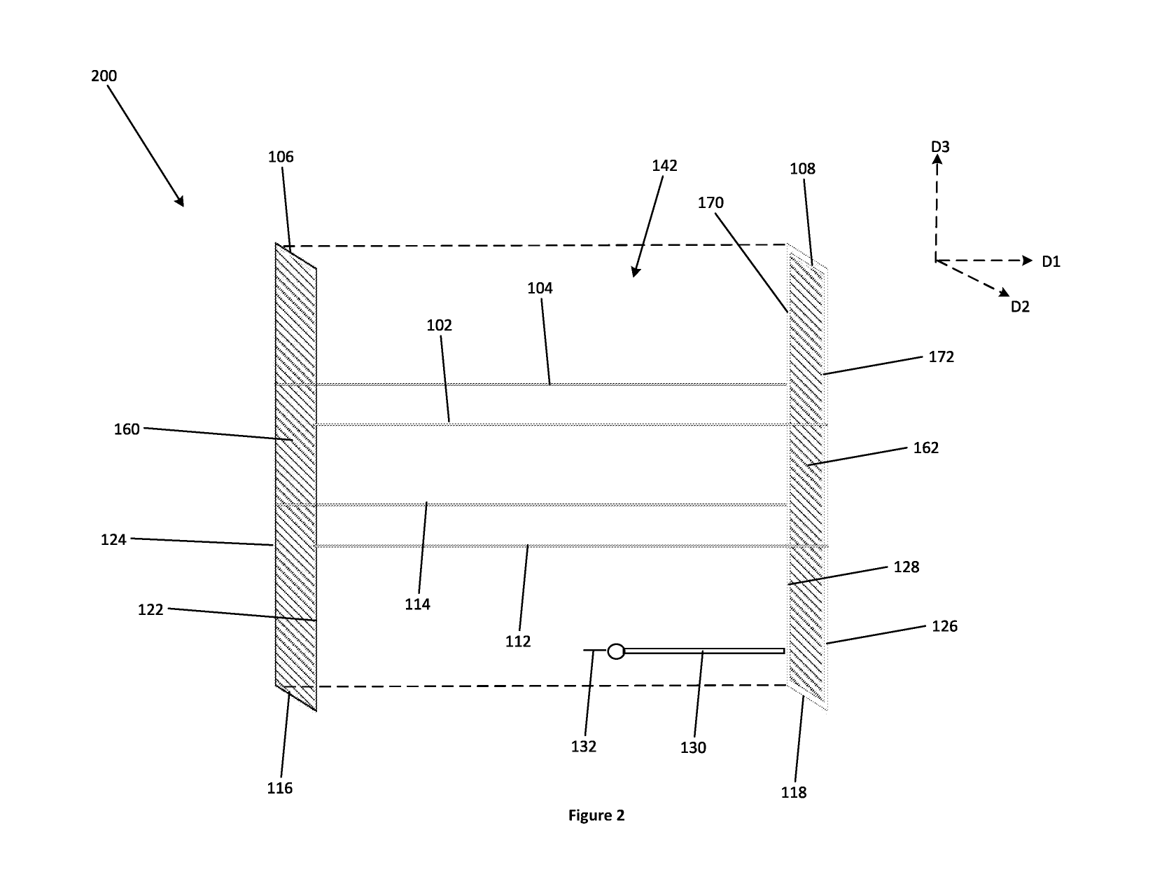

Referring now to FIG. 2, first left vertical member 122, second left vertical member 124, first upper horizontal member 106 and first lower horizontal member 116 define first filter enclosure 160. The first filter enclosure 160 is capable of having an air filter inserted through the enclosure such that, upon an air filter being inserted into first filter enclosure 160, frame 100 encircles the inserted air filter.

In FIG. 1, an example air filter 150 is shown inserted into the frame 100. In this example, the air filter 150 is a conventional furnace filter having a cardboard border suspending a paper filter 152 inside it. The airflow through planes perpendicular to the first and second flow through apertures 140 and 142 (shown in FIGS. 4-5) and passes through this paper filter 152. In other embodiments, different types of filter may be accommodated by the frame, such as filters made from a flexible material such as paper or fabric, without a stiff cardboard border. In place of this stiff cardboard border to maintain the shape of the filter, the flexible filter may be held in place by attachment directly to one or more points of attachment to the frame 100 itself.

Referring again to FIG. 2, first right vertical member 126, second right vertical member 128, second upper horizontal member 108 and second lower horizontal member 118 defines a second filter enclosure 162.

In some embodiments, second filter enclosure 162 is further defined by sidewalls 170 and 172 attached to at least one of first right vertical member 126, second right vertical member 128, second upper horizontal member 108 and second lower horizontal member 118, the sidewalls extending parallel to first filter enclosure 160 into second filter enclosure 162, so that an air filter inserted into first filter enclosure 160 is unable to be pushed past second filter enclosure 162.

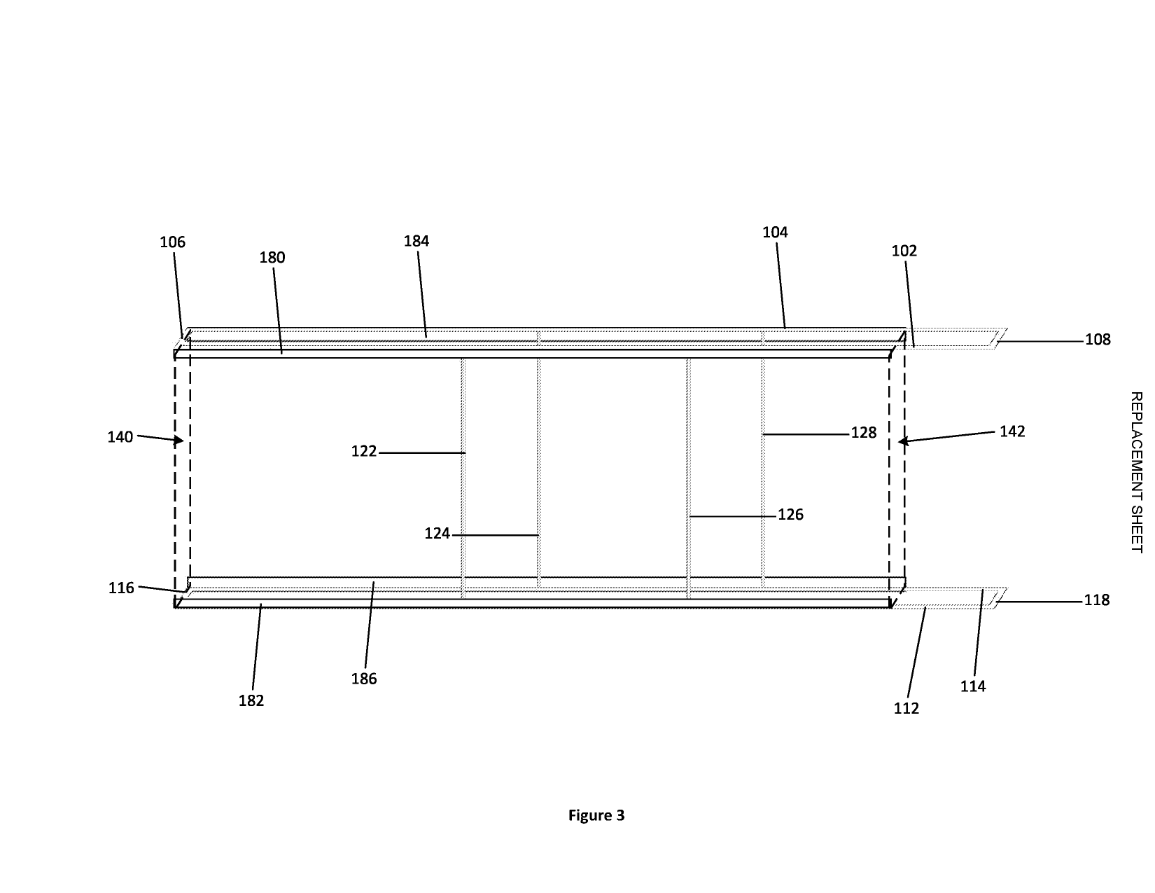

Referring now to FIG. 3, in one example embodiment, the first lower longitudinal member 112, and first upper longitudinal member 102, are further defined by sidewalls 180 and 182 extending parallel to the second flow-through aperture 142 into the first flow-through aperture 140.

In another example embodiment, second lower longitudinal member 114, and second upper longitudinal member 104 are further defined by sidewalls 184 and 186, extending parallel to the second flow-through aperture 142 into the first flow-through aperture 140.

Referring again to FIG. 2, an example embodiment of the present disclosure includes a smart air filter housing 200 wherein the positioning of first upper longitudinal member 102, second upper longitudinal member 104, first lower longitudinal member 112, and second left vertical member 124 relative to the other members is different from that in FIG. 1. In FIG. 2, members first upper longitudinal member 102, second upper longitudinal member 104, first lower longitudinal member 112, and second left vertical member 124 are not connected to the edges of the other members.

Referring again to FIG. 3, an example embodiment of the present disclosure includes smart air filter housing wherein the positioning of first left vertical member 122, second left vertical member 124, first right vertical member 126 and second right vertical member 128 relative to the other members is different from that in FIG. 1. In FIG. 3, first left vertical member 122, second left vertical member 124, first right vertical member 126 and second right vertical member 128 are not connected to the edges of the other members.

Collectively, first upper longitudinal member 102, second upper longitudinal member 104, first upper horizontal member 106, second upper horizontal member 108, first lower longitudinal member 112, second lower longitudinal member 114, first lower horizontal member 116, second lower horizontal member 118, first left vertical member 122, second left vertical member 124, first right vertical member 126, and second right vertical member 128 define an air filter frame.

An example smart air filter housing 100 may further consist of a connector. Connectors may be connected to the air filter frame at any point along same. Connectors may protrude from any point on the air filter frame into any portion of first or second flow-through apertures 140 and 142.

For example, referring to FIG. 2, connector 130 may protrude from second right vertical member 128 into the second flow-through aperture 142. Connector 130 may also connect to a data measurer 132. In the example embodiment, data measurer 132 is a microphone, as depicted in FIG. 2.

Connectors 130 may protrude from the air filter frame parallel to the first and second air filter frame apertures 140 and 142. Connectors 130 may also extend from the air filter frame in any direction so long as they do not impede the air filter being inserted into the smart air filter housing 100.

Connectors 130 are suitable to connecting at one end to any data measurer, including but not limited to microphones, optical sensors, air quality sensors, air pressure sensors, compliance determiners, etc., or to other components such as wireless communicators, energy harvesters, processors, and connecting to the air filter frame at the other end, as demonstrated in FIG. 2. The connector may be configured to direct the data measurer towards the air filter frame at any angle of incidence.

The connector 130 may be configured to direct the data measurer to be parallel to any portion of the air filter frame, or to direct the data measurer toward an inserted air filter. Connectors 130 may be configured to position data measurers in any direction or in any orientation. Connectors 130 may be connected at any point to any other members of the air filter frame.

Multiple variations of smart air filter housing 100 are possible by combining as few or as many connectors and/or sidewalls to attach as many or as few data measurers, energy harvesters, processors, controllers or wireless communicators.

Connectors 130 may be of varying length. Connectors 130 can be short, such as one or two inches in length, so that when a data measurer is connected to the connector, the data measurer protrudes just past the air filter frame. Sidewalls may be of any thickness and protrude into any of the enclosures so long as they do not impede the smart frame housing 100 from housing and accepting an air filter.

All of the above-described members are connected to one another. The connection is accomplished using known techniques, including gluing, fastening, crimping, riveting, fastening, fusing, welding, etc. At least one of the frame segments may be attachable to and detachable from another of the frame segments.

In some example embodiments, the smart air filter housing 100 is a single piece created from a molding process.

The air filter frame, sidewalls, and any connectors may be constructed of wood, or metal, or any other suitable material with known properties suitable to holding the weight of at least one connector, air filter and data measurer, and maintaining the structural rigidity required to hold an air filter in place in a HVAC return air duct.

The air filter frame, connectors and/or sidewalls are all suitable to attach data measurers, energy harvesters, processors, controllers or wireless communicators, etc.

Data measurers are devices capable of measuring physical phenomena on or near an air filter and producing data readings based on these measurements. Data measurers may include optical emitters, optical receivers, microphones, humidity sensors, temperature sensors, air quality sensors, pressure sensors, MEMS force sensors, force sensors compliance determiners, and capacity determiners, etc.

At least one data measurer may be in communication with a controller, outputting physical phenomena readings, referred to as readings, to a controller. The controller may be in communication with a remote controller. Data measurers may be in communication with a wireless communicator providing the readings to same. A person skilled in the art will appreciate that the data measurers, processors, controllers, wireless communicators, etc. are operably coupled to allow for communication between said elements.

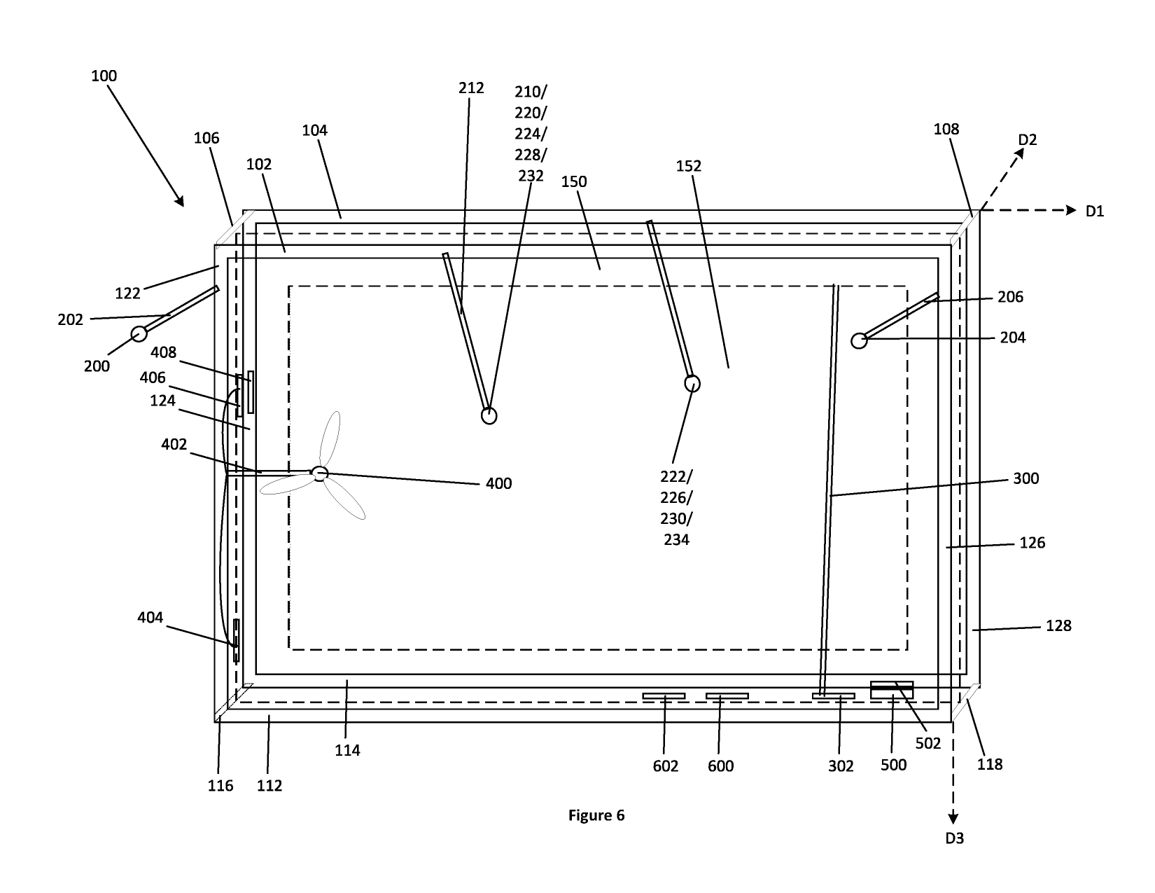

Referring now to FIG. 6, in one example embodiment, an optical emitter 200 is connected to a first air filter frame member via connector 202, and an optical receiver 204 is connected to a second, opposite air filter frame member via connector 206 (collectively the optical sensors). The optical emitter 200 and optical receiver 204 are positioned to face one another. The optical emitter 200 generates a beam of light that is received by the optical receiver 204. When the air filter is dirty, the particulate matter will create an optical barrier that will occlude the light emitted by the optical emitter 200 from reaching the optical receiver 204. The length of connectors 202 and 206 can be configured to position the optical emitter 200 and optical receiver 204 any distance from the first left vertical member 122 and first right vertical member 126 to establish a threshold of dirtiness or blockage.

In another example embodiment, the optical emitter and optical receiver are contained in one unit, optical sensor 210, and optical sensor 210 is directed towards the air filter via connector 212. The optical emitter within optical sensor 210 emits a beam of light towards the air filter, and the optical receiver within optical sensor 210 determines one or more characteristics of the light reflected from the air filter, such as light intensity. The angle of incidence and distance from the optical sensor 210 to the air filter 150 is determined by the direction and configuration of connector 212.

Optical sensor 210 and optical emitter 200 and optical receiver 204 may in some embodiments be replaced or supplemented by any data measurer capable of being connected to a connector.

In one example embodiment, a microphone 220 is connected to connector 212. The microphone detects any sound made by air passing through an air filter. The sound detected by the microphone, including sound characteristics such as pitch, amplitude, and including any characteristics of varying sounds, including frequency, etc., may be indicative of the dirtiness of the filter.

In another example embodiment, first and second microphones 220 and 222 are connected to the air frame via connectors 212 and 214 so that the first and second microphones 220 and 222 are located on the plane of the first and second flow-through apertures 140 and 142. The microphones 220,222 detect sound characteristics of the air before and after is passes through the air filter (not shown). The difference between the sounds detected before and after the air filter is indicative of the dirtiness of the air filter. Furthermore, the sound characteristics of the detected sounds may individually be indicative of the dirtiness of the air filter.

In another example embodiment, an air pressure sensor 224 is connected to connector 212. The connector may be located or positioned in any manner in the plane of the first flow-through aperture 140 or the second flow-through aperture 142. The air pressure reading may be indicative of the dirtiness of the air filter.

In another example embodiment, first and second air pressure sensors 224 and 226 are connected to connectors 212 and 214 respectively, so that the first and second air pressure sensors 224 and 226 are located on the plane of the first and second flow-through apertures 140 and 142. The difference in the readings between the pressure in the first and second air pressure sensors 224,226 may be indicative of the dirtiness of the air filter.

In another example embodiment, a MEMS force sensor 228 is connected to connector 212. The connector may be located or positioned in any manner in the plane of the first flow-through aperture 140 or the second flow-through aperture 142. The force reading may be indicative of the dirtiness of the air filter. A MEMS force sensor is more sensitive to force variations compared to an air pressure sensor, allowing for more detailed identification of force or pressure measurement variation.

In another example embodiment, first and second MEMS force sensors 228 and 230 are connected to connectors 212 and 214 respectively, so that the first and second MEMS force sensors 228 and 230 are located on the plane of the first and second flow-through apertures 140 and 142. The difference in the readings between the force in the first and second MEMS force sensors 228 and 230 may be indicative of the dirtiness of the air filter.

In another example embodiment, an air quality sensor 232 is connected to connector 212. The connector may be located or positioned in any manner in the plane of the first flow-through aperture 140 or the second flow-through aperture 142. The air quality sensor can measure the level of particulate matter in the air, or chemical matter, etc. The reading may be indicative of the dirtiness of the air filter as well as the air quality in general.

In another example embodiment, first and second air quality sensors 232 and 234 are connected to connectors 212 and 214 respectively, so that the first and second air quality sensors 232 and 234 are located on the plane of the first and second flow-through apertures 140 and 142. The difference in the readings between the various sensors may be indicative of the dirtiness of the air filter.

In another example embodiment, the air filter 150 inserted into the air filter frame contains conductive element 300. The conductive element 300 performance is impeded when the air filter 150 is dirty and/or blocked. The degree of performance impedance may be correlated to the dirtiness and/or blockage of the air filter. The air filter frame is connected to a capacitance determiner 302 via a conductive element 300. The capacitance determiner 302 may be connected to the air filter frame via a connector or the capacitance determiner 302 may be connected to the frame directly as shown in FIG. 6. The capacitance determiner 302 is positioned so that it is in contact with conductive element 300. The conductivity of the conductive element 300 in the air filter 150, determined by the capacitance determiner 302, may measure the resistance in the circuit, and may be indicative of the dirtiness of the air filter.

In one example embodiment, an energy harvester 400 is connected to a connector 402. The energy harvester may consist of turbine blades which turn in response to air flowing through the HVAC system, creating energy. In one example embodiment, the energy harvester 400 may send power harvested to a battery 404 located on the air filter frame.

In another example embodiment, energy harvester 400 may be configured to transmit any power harvested to a battery 408 located on the air filter 150 and connected to a power connector 406.

A power connector is at least connected to the air filter frame and the power source, which may be a battery.

In another example embodiment, the air filter frame may have a compliance determiner 500. Compliance determiner may be connected to the air filter frame via a connector (not shown), directly to the frame, etc. The compliance determiner 500 is configured to determine whether the air filter inserted into the air filter frame is suitable to the operation of the air filter frame. It does this by determining whether the filter complies with a compliance standard, as described below.

Compliance determiner 500 requires a complimentary compliance element 502 to be connected to air filter 150. The compliance element 502 may simply generate or incorporate data which indicates that the air filter is of a certain make, status, manufacture date, etc. The compliance determiner 500 may communicate directly with the complimentary compliance element 502, for example via a Radio Frequency Identification (RFID) tag, or may communicate with the compliance element via the wireless communicator 600.

In one example embodiment, the compliance determiner 500 and compliance element 502 are mechanical elements, which may contain physical means of preventing air filter 150 from being inserted into smart air filter housing 600 through a physical mechanism, such as a series of grooves, which prevent a non-suitable air filter from being inserted. The physical mechanisms on compliance determiner 500 and compliance element 502 are complimentary to allow for interlocking.

The compliance determiner may further be an electrical circuit that is only connected in the event that the compliance element has a suitable number of teeth in a suitable position.

In one example embodiment, the compliance determiner 500 assesses the data received from the compliance element 502 and determines whether it meets selection criteria.

In some embodiments, the smart air filter housing is equipped with a wireless communicator 600. The wireless communicator may contain a radio capable of performing as a user device link, or a gateway link and may further comprise an antenna. The wireless communicator may contain a series of radios with multiple antennas configured to operate on different frequencies, or a single wireless transceiver.

The wireless communicator 600 may be connected to a controller 602, which controls and reacts to messages received by the wireless communicator 600.

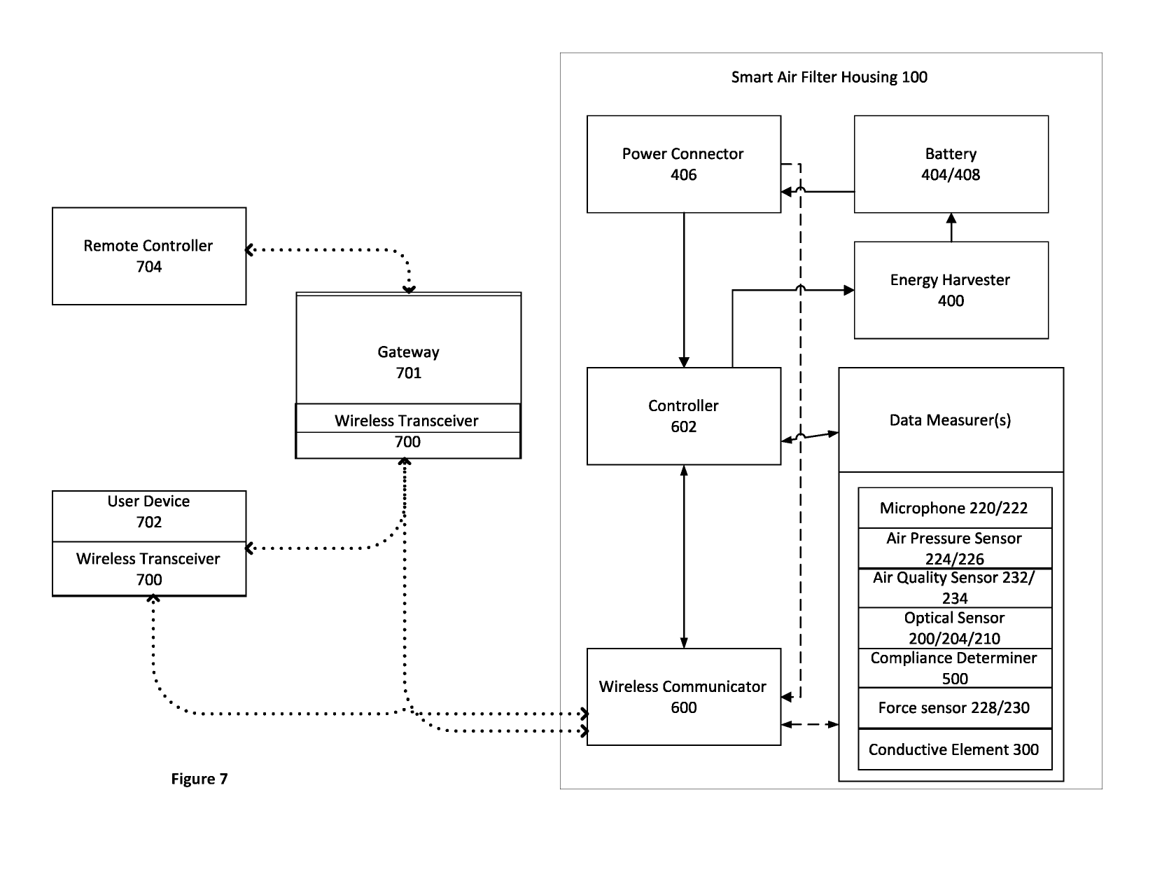

Referring now to FIG. 7, in an example embodiment, within smart air filter housing 100, controller 602 is powered by power connector 406, which is connected to a battery 404/408. Wireless communicator 600 may be powered either through the controller 602 or in alternate embodiments, wireless communicator 600 may be powered directly by power connector 406.

Controller 602 may send or receive messages to/from wireless communicator 600. Controller 602 may further send or receive messages to/from data measurer(s), which may include first and second microphones 220 and 222, first and second air pressure sensors 226 and 224, etc. The messages may be instructions, or in the event that the data measurer(s) are sending messages to the controller, the messages are readings. Controller 602 also communicates with energy harvester 400, which in turn provides power back to the battery 404 or 408.

In an alternate embodiment, one or more data measurers send readings to wireless communicator 600, wherein both the data measurers and the wireless communicator 600 are connected to the air filter frame.

In some embodiments, the wireless communicator 600 has a controller built into same, which is configured to communicate with an external first wireless transceiver 700. In one example embodiment wireless communicator 600 sends readings from the data measurer(s) to first wireless transceiver 700. In an alternate embodiment, readings may be sent from the data measurer(s) to controller 602, which may instruct the wireless communicator 600 to send the readings to the first wireless transceiver 700. Wireless communicator 600 may be a user device link (not shown), a gateway link (not shown), etc.

First wireless transceiver 700 may be a user device 701, a gateway 701, etc.

In some embodiments, the smart air filter housing is equipped with the user device link, which may or may not be built into the wireless communicator 600, for communicating with a user device 702. The user device 702 is operated by a user and may be a mobile electronic device (such as a smartphone), a laptop or desktop computer, or another electronic device (such as a remote control unit). The user device link may be a wired or wireless communication link, such as a Bluetooth™ Low Energy (BLE) link. In some embodiments, the user device link allows for direct communication between the user device 702 and the smart air filter housing 100 without going through any intermediary devices or networks. Some of these embodiments make use of a user device link that is configured to wake the smart air filter housing from a low-power or sleep mode in response to communications from the user device.

In some embodiments, the smart air filter housing 100 is provided with a gateway link, which may or may not be built into wireless communicator 600, for communicating with a gateway. The gateway link may in some embodiments be a long-range wireless link such as a low-power low-frequency (LPLF) radio link. The gateway 701 may in some embodiments be an electronic device in communication with one or more data producing HVAC elements over various gateway links. In some embodiments, the gateway 701 is configured to directly control an HVAC system for the building. In other embodiments, the gateway 701 is configured to control the HVAC system indirectly through one or more other devices and/or user devices 702. The gateway 701 may respond to communications from one or more of the smart air filter housings to set the operating mode or parameters of the HVAC system via the remote controller 704 (e.g. power level of heating, power level of cooling, humidity settings, off).

Thus, in some embodiments the smart air filter housing comprises two radios: one being a low power, but short range, Bluetooth (BLE) radio and other being a low power, lower frequency (LPLF) radio but with a longer range enabling it to have a wider area of coverage. The smart air filter housing 100 communicates via BLE with a smart phone or similar user device for short range communication and connects with a gateway 701, which can be a further distance away, via the LPLF radio. The smart air filter housing 100 receives a wireless command from the gateway 701 or the smart phone to determine the status of the air filter.

In another example embodiment, the data measurer may be configured, using an onboard controller or otherwise, to go into a low power mode when inactive after a certain period of inactivity, or after a reading has been sent. In the example embodiment, the data measurer can be activated from the low power mode in response to a wake up event.

In another example embodiment, the wake up event may be received from wireless communicator 600 which has an onboard circuit allowing it to turn on the data measurer without resorting to controller 602.

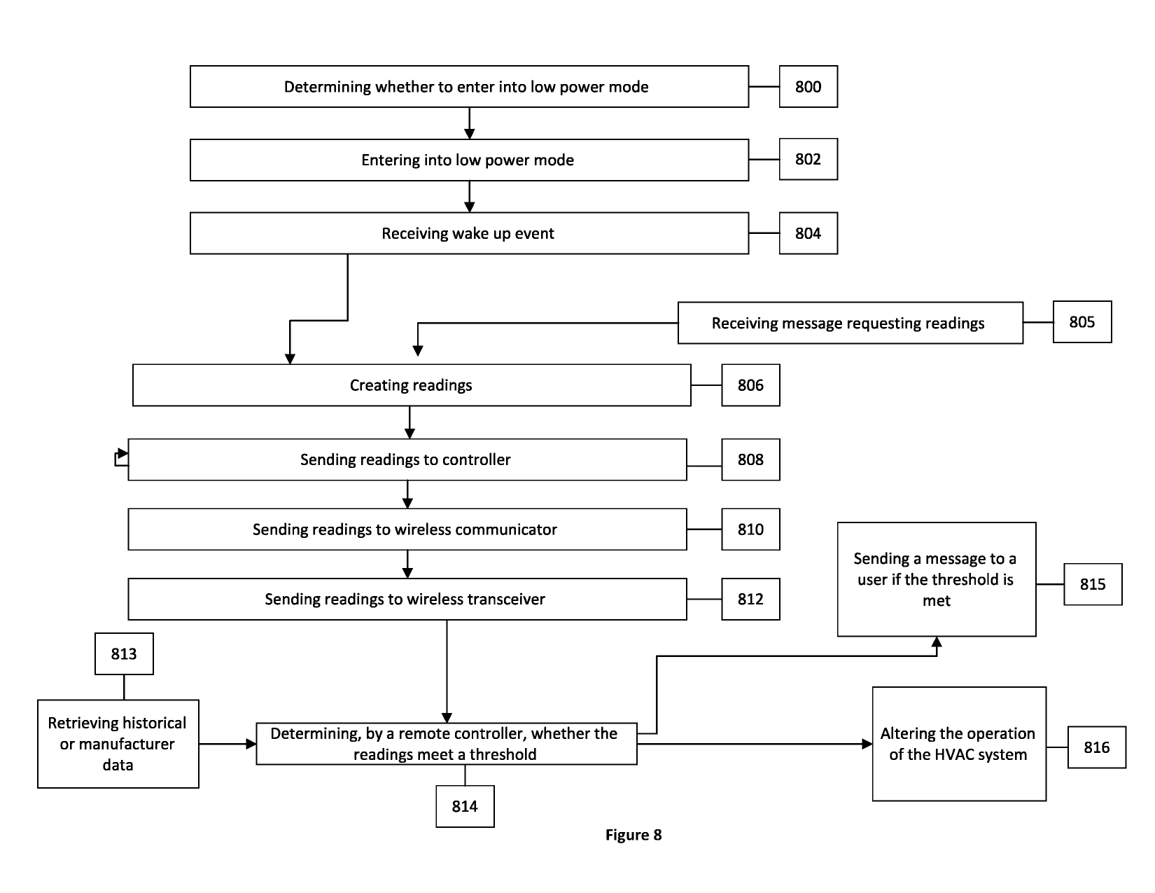

Referring now to FIG. 8, in some embodiments, the smart air filter housing will spend the majority of its time in a low-power or sleep mode, and communications with the gateway only take place periodically during a wake-up period. This may make the smart air filter housing less immediately responsive to the gateway than they are to the user device.

In one example embodiment, at step 800, a controller, such as a processor coupled to a memory, or controller, may be in communication with a data measurer, such as a microphone or other sensor. The controller determines whether the data measurer or wireless communicator should operate in a low power mode based on certain criteria. At step 802, the controller operates the data measurer or wireless communicator in a low power mode if the criteria are met.

At step 804, the controller may activate the data measurer or wireless communicator in response to a receiving a wake up event.

In one example embodiment, the controller is programmed to have wake-up events scheduled at a regular interval, or at a particular time. In another example embodiment, a wake up event occurs when a wireless communicator receives a message from a first wireless transceiver 700. The message may contain instructions to wake up the data measurer, or to take measurements at certain intervals, or at certain times, which the controller may implement.

In another example embodiment, shown in step 805, the wireless communicator or data measurer(s) are not placed in a low power mode. Readings are taken upon receiving a message requesting readings from an external wireless transceiver.

In one embodiment, a remote controller utilizing operational logic may send a message to the controller requesting readings via the first wireless transceiver.

At step 806, the data measurer(s) create the data measurements, or readings. The readings are sent to the controller in step 808, which readings are forwarded by the controller to the wireless communicator for broadcasting in step 810.

In some example embodiments, the readings are sent by the data measurer(s) directly to the wireless communicator, wherein a controller is integrated into the wireless communicator.

At step 812, the readings are sent by the wireless communicator to an external wireless transceiver.

In one example embodiment, as shown in step 804, the wireless transceiver sends the data to a remote controller. The remote controller may coordinate the operation of the HVAC system using readings data and/or operational logic. In some embodiments, the remote controller, utilizing operational logic, determines, depending on whether the readings meet a threshold, whether to take one or both of or neither of the steps 815 and 815, being sending a message to a user that the threshold is exceeded (such as via a user interface on the user device, on the remote controller, or on another device in direct or indirect communication with the remote controller), or altering the operation of the HVAC system, respectively. In some embodiments the threshold may be preprogrammed or determined by the remote controller utilizing the operational logic.

The operational logic may include schedule data for changing HVAC air filters. The operational logic may further comprise instructions to change HVAC operating parameters in response to sensor readings. The operational logic may also comprise instructions to notify a user in response to sensor readings at various intervals, dates, etc.

The operational logic may determine a threshold for air filter blockage based on the historical sensor data. For example, the remote controller may compare the sensor readings over time and take action when the difference between a sensor reading at a first time and the sensor reading at a second time exceeds a threshold. In some embodiments, this threshold may be determined based on user feedback from past filter change incidents based on a user's visual inspection of the filter being changed.

In another example embodiment, the remote controller, utilizing operational logic, determines whether the threshold is met with reference to one of historical data or manufacturer data, as shown in Step 813, before determining whether to continue to steps 815 or 816.

In an example embodiment, utilizing the operational logic may cause the remote controller to send a message to the controller requesting readings via the first wireless transceiver. As a result of receiving the message from the remote controller, the smart air filter housing may cause a data measurer to take readings, send the readings to the wireless communicator, which wireless communicator further relays the readings back to the first wireless transceiver by sending a command to the data measurer or a separate sensor controller for the controller to activate the data measurer, which would respond with a data reading. The controller can be connected to an air filter frame and send readings to a wireless communicator. One or more data measurers or sensors, coupled to the storage and controller, provide the sensor readings upon receiving the command from the controller, and the readings may be sent to a gateway.

In another embodiment, the remote controller stores manufacturer data in regards to the air filter inserted. The operational logic determines a threshold for air filter blockage based on the manufacturer data.

The remote controller may be a server or set of servers on the Internet or another network in communication with the gateway. In other embodiments, the remote controller may be an electronic device in communication with the gateway through a communication link rather than over a network. In still other embodiments, the remote controller may be a software or hardware module included as part of the same device as the gateway.

In another example embodiment, the remote controller may have operational logic which alters the operation of the HVAC system in response to readings received from data measurers. For example, if the operational logic determines that the filter is blocked on the basis of microphone readings, the controller may decrease the HVAC operating speed in order to prevent fires.

The smart air filter(s), gateway, and remote controller may be used in various combinations in different embodiments, as described in detail herein. In some embodiments, a smart air filter system is provided to notify a user in the event of a determination of blockage in reference to a threshold. The system may be employed to provide command and status information to an HVAC control device that controls the HVAC system and turns it on or off, or notifies a maintenance employee as to the status of an air filter.

In some embodiments, the functionality of the smart air filter housing may be accessed using a software Application Program Interface (API). The smart air filter housing can use the API to communicate with the HVAC control system over a wired or wireless communication link.

In other embodiments, a smart air filter system can directly communicate with a gateway that can control the HVAC system (e.g., turn it on and off, send notifications).

In an embodiment, a smart filter comprises a frame, a sensor for measuring the amount of dirt or impurity accumulated on the filter, a wireless means of communication to report the condition of the filter, a microprocessor to control the sensor and the radio and a battery, connected to an air filter and a power connector to power the electronics.

A person skilled in the art would appreciate that all components producing or requiring electrical power are operably connected to a power source suitable to powering at least one data measurer and wireless communicator.

A person skilled in the art would further appreciate that all elements producing data or taking readings are operably connected to a wireless communicator.

A person skilled in the art would further appreciate that the wireless communicator is capable of communicating with a wireless transceiver, which may be a wireless receiver, a gateway, a user device, etc.

Similarly, the techniques described above can be implemented by programmable circuitry programmed and/or configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Although various components of the example devices and systems are described and illustrated as a single component, in other embodiments their functions may be split among multiple different components. For example, a data measurer may have a controller built into same, which allows for the data measurer to send readings to the wireless communicator directly. The wireless communicator may have its own onboard controller to handle and process incoming messages, or the wireless communicator may be in communication with a controller on the air filter frame which may receive and handle messages received by the wireless communicator.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A smart air filter housing comprising:
an air filter frame suitable to being inserted into a return air chamber of an HVAC system, for containing an air filter;
at least one data measurer connected to the air filter frame and configured to measure data related to the state of an air filter resident within the frame;
a controller connected to the air filter frame, in communication with the at least one data measurer;
a wireless communicator connected to the air filter frame, in communication with the controller; and
a power connector, connected to the air filter frame, configured to receive power from a power source suitable to powering the at least one data measurer and the wireless communicator.

2. The smart air filter housing of claim 1, wherein at least one of the data measurer and the wireless communicator is connected to the air filter frame via a connector.

3. The smart air filter housing of claim 1, wherein the air filter frame is made of one or more materials selected from the following list: metal, wood, and plastic.

4. The smart air filter housing of claim 2, wherein the connector is positioned to direct the data measurer towards the air filter.

5. The smart air filter housing of claim 2, wherein connector is positioned to direct the data measurer parallel to the air filter.

6. The smart air filter housing of claim 1, further comprising a battery, wherein the battery is connected to the air filter and the power connector.

7. The smart air filter housing of claim 1, wherein the battery is connected to the air frame filter and the power connector.

8. The smart air filter housing of claim 1 further comprising an energy harvester connected to the air filter frame and the power connector, the energy harvested being configured to harvest energy and provide the energy to the power connector.

9. The smart air filter housing of claim 1, wherein the at least one data measurer comprises at least one of the following: an optical emitter, an optical receiver, a pressure sensor, a capacitance determiner, a temperature sensor, a microphone, a humidity sensor, a force sensor, an air quality sensor, and a compliance determiner.

10. The smart air filter housing of claim 1 wherein the at least one data measurer comprises a compliance determiner configured to determine whether an air filter inserted into the frame complies with a compliance standard.

11. The smart air filter housing of claim 1 wherein the at least one data measurer comprises a compliance determiner configured to allow an air filter if a compliance element attached to the air filter meets a compliance standard.

12. The smart air filter housing of claim 1 wherein the wireless communicator is configured to communicate to a first wireless transceiver via Near Field Communication (NFC), Radio Frequency ID (RFID).

13. A method of operating a smart air filter housing comprising:
sending readings from a data measurer connected to an air filter frame to a wireless communicator;
sending the readings from the wireless communicator to a first wireless transceiver.

14. The method of claim 13, wherein the step of sending readings from the data measurer to the wireless communicator comprises:
sending the readings from the data measurer to a controller, and
sending the readings from the controller to the wireless communicator.

15. The method of claim 13, wherein one or more of the data measurer and the wireless communicator operates in a low power mode, and awakens in response to a wake up event.

16. The method of claim 15, wherein the wake up event comprises receiving a message from the first wireless transceiver.

17. The method of claim 13, wherein the step of sending readings to the first wireless transceiver occurs in response to receiving a message from the first wireless transceiver.

18. The method of claim 17, wherein the message from the first wireless transceiver is sent as a result of a remote controller utilizing operational logic.

19. The method of claim 13, wherein, in response to sending the readings from the wireless communicator to the first wireless transceiver, a remote controller utilizes operational logic to determine whether the readings meet a threshold.

20. The method of claim 19, wherein, if the threshold is satisfied, the remote controller sends a message to a user device.

21. The method of claim 19, wherein, if the threshold is satisfied, the remote controller alters the operation of an HVAC system.

22. The method of claim 19, wherein the threshold is determined based on at least one of historical sensor data and manufacturer data.
